(19) United States
(12) Patent Application Publication
(10) Pub. No.: US 2008/0028451 A1
(43) Pub. Date: Jan. 31, 2008

(54) Projection type display device and control method thereof

(75) Inventor: Kazuyuki Takeda, Ora-gun (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/880,988

(22) Filed: Jul. 24, 2007

(30) Foreign Application Priority Data
Jul. 28, 2006 (JP) 2006-206706

(51) Int. Cl. H04L 9/32

(52) U.S. Cl. 726/7

(57) ABSTRACT

According to one embodiment, a password unit is provided which controls a main unit so that the main unit can be active when an input password matches with a preset password. Control is performed to request the input of the password in response to an operation of requesting the activation of the main unit unless a control panel configured detachably from the main unit is attached to the main unit even when the password unit is set to an off-state.

### CROSS-REFERENCE TO RELATED APPLICATIONS

This application is based upon and claims the benefit of priority from Japanese Patent Application No. 2006-206706, filed Jul. 28, 2006, the entire contents of which are incorporated herein by reference.

### BACKGROUND

1. Field

One embodiment of the invention relates to a projection type display device typified by, for example, a liquid crystal color projector, and an improvement of a control method thereof.

2. Description of the Related Art

As is well known, a projection type display device as described above is capable of displaying information in a large screen in a magnified manner, and is therefore convenient when the information is to be visually recognized by a large number of people at the same time. Thus, there have been increasing opportunities for the projection type display devices to be installed in places where a large number of people visit, such as schools, companies, multipurpose halls, etc.

In this case, various measures have been contemplated in the present situation to protect the projection type display devices against theft, tampering, unauthorized use, etc. For example, Jpn. Pat. Appln. KOKAI Publication No. 2005-192095 has disclosed the configuration of an electronic device, wherein an operation panel is detachable from the main body of the device, and the device can only be operated by an operation panel whose operation panel ID matches.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing one embodiment of this invention to explain the appearance of a color projector;

FIG. 2 is a perspective view showing a cabinet and a control panel of the color projector in the embodiment to explain the relation therebetween;

FIG. 3 is a top view showing the cabinet and the control panel of the color projector in the embodiment to explain the relation therebetween;

FIG. 4 is a block configuration diagram showing to explain the outline of a signal processing system of the color projector in the embodiment;

FIG. 5 is a block configuration diagram showing to explain a function of detecting the connection between the cabinet and the control panel of the color projector in the embodiment;

FIG. 6 is a diagram showing to explain the main operation performed by a control unit of the color projector in the embodiment;

FIG. 7 is a flowchart showing to explain part of the main operation performed by the control unit of the color projector in the embodiment;

FIG. 8 is a flowchart showing to explain the rest of the main operation performed by the control unit of the color projector in the embodiment;

FIG. 9 is a diagram showing to explain one example of a menu screen when various functions of the color projector in the embodiment are set;

FIG. 10 is a diagram showing to explain one example of a method of storing the password of the color projector in the embodiment; and

FIG. 11 is a diagram showing to explain another example of the method of storing the password of the color projector in the embodiment.

### DETAILED DESCRIPTION

Various embodiments according to the invention will be described hereinafter with reference to the accompanying drawings. In general, according to one embodiment of the invention, a password unit is provided which controls a main unit so that the main unit can be active when an input password matches with a preset password. Control is performed to request the input of the password in response to an operation of requesting the activation of the main unit unless a control panel configured detachably from the main unit is attached to the main unit even when the password unit is set to an off-state.

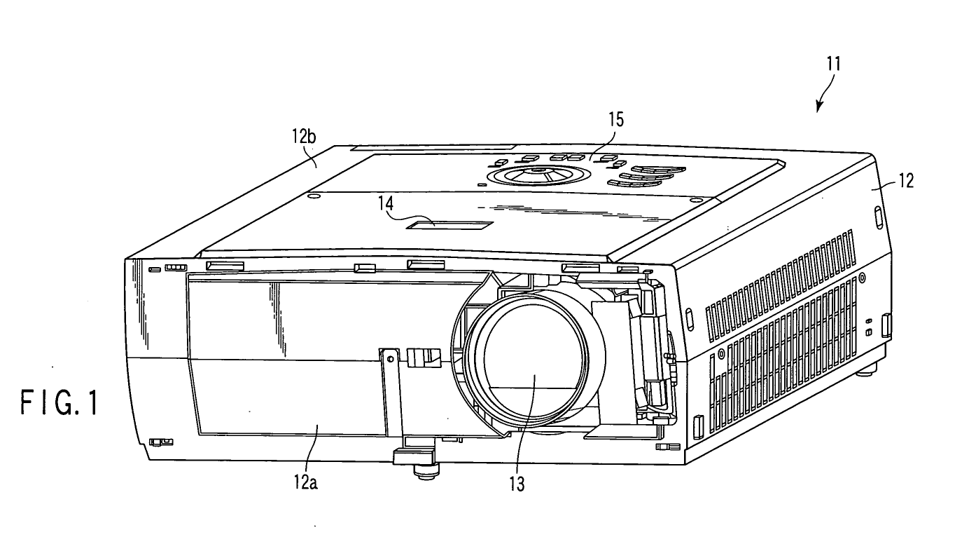

FIG. 1 shows the appearance of a color projector 11 described in this embodiment. That is, this color projector 11 has a stationary cabinet 12 formed to have a thin box shape and serving as the main unit of the projector.

Furthermore, in this cabinet 12, a projection lens 13 is disposed at one end of its front panel 12a. This projection lens 13 projects imaged information in a magnified manner and displays the information in a later-described screen disposed in front of the cabinet 12 and serving as an image projection surface.

Still further, in the cabinet 12, a display unit 14 and an operation unit 15, which will be described in detail later, are disposed in its upper panel 12b. Of these units, the display unit 14 displays the current state of the color projector 11 or displays a menu screen for setting the color projector 11 to various modes.

Moreover, the operation unit 15 is provided with a power supply key, and also provided with various keys for controlling the color projector 11 to bring this color projector into various operation states and a stop state and for setting the color projector 11 to various modes. These keys are placed so that they are exposed from the upper panel 12b for the operation of a user.

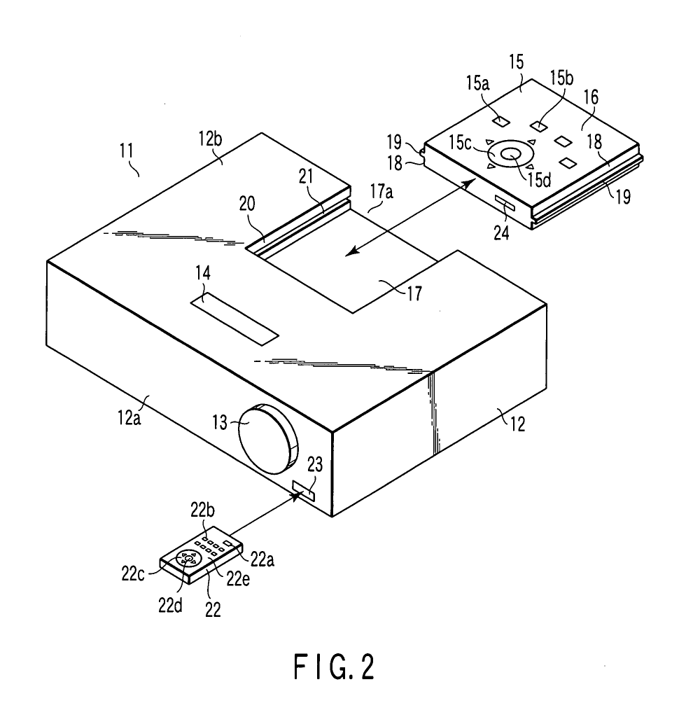

Here, the operation unit 15 provided with the various keys including the power supply key as described above is configured as a control panel 16 formed into substantially one plate shape separately from the cabinet 12, as shown in FIG. 2. Further, this control panel 16 is configured detachably from the cabinet 12.

That is, in a rear end central portion of the upper panel 12b of the cabinet 12, an attachment portion 17 is formed which has a concave shape in the upper panel 12b and which provides an opening 17a in the rear surface of the cabinet 12. Then, the control panel 16 is inserted from the opening 17a formed in the rear surface of the cabinet 12 into the attachment portion 17 so that its flat surface in which the operation unit 15 is formed may be parallel with the upper panel 12b, such that the control panel 16 can be attached to the attachment portion 17.

In this case, in the control panel 16, a collar-shaped guide portion 19 parallel with the direction of insertion into the attachment portion 17 is protrusively provided on each of a pair of side surfaces 18 parallel with the direction of insertion into the attachment portion 17. This guide portion 19 is formed in a central portion of the control panel 16 in its thickness direction.

Furthermore, in the attachment portion 17, a guide groove 21 is formed in each of a pair of side surfaces 20 parallel with the direction of insertion into the attachment portion 17, so that the guide portions 19 of the control panel 16 are inserted into the guide grooves 21, and the guide grooves 21 guide the insertion of the control panel 16 into the attachment portion 17.

Thus, the control panel 16 is inserted into the attachment portion 17 from the opening 17a so that its guide portions 19 are inserted into the guide grooves 21, and then the control panel 16 is inserted into the attachment portion 17 so that its flat surface in which the operation unit 15 is formed may be parallel with the upper panel 12b, thereby enabling the attachment of the control panel 16 to the attachment portion 17.

In addition, in the operation unit 15 of the control panel 16, there are disposed a power supply key 15a for allowing light projection via the projection lens 13, a menu key 15b for causing the menu screen to be displayed on the display unit 14, a direction key 15c for selecting from a plurality of options included in the menu screen displayed on the display unit 14, a decision key 15d for deciding the option selected by the direction key 15c, etc.

Furthermore, in the cabinet 12, a receiving unit 23 is disposed in its front panel 12a to receive operation information sent from a wireless remote controller 22 and transmits the operation information to a signal processing system in the cabinet 12. In this remote controller 22, there are disposed a power supply key 22a for allowing light projection via the projection lens 13, a menu key 22b for causing the menu screen to be displayed on the display unit 14, a direction key 22c for selecting from a plurality of options included in the menu screen displayed on the display unit 14, a decision key 22d for deciding the option selected by the direction key 22c, a ten-key pad 22e, etc.

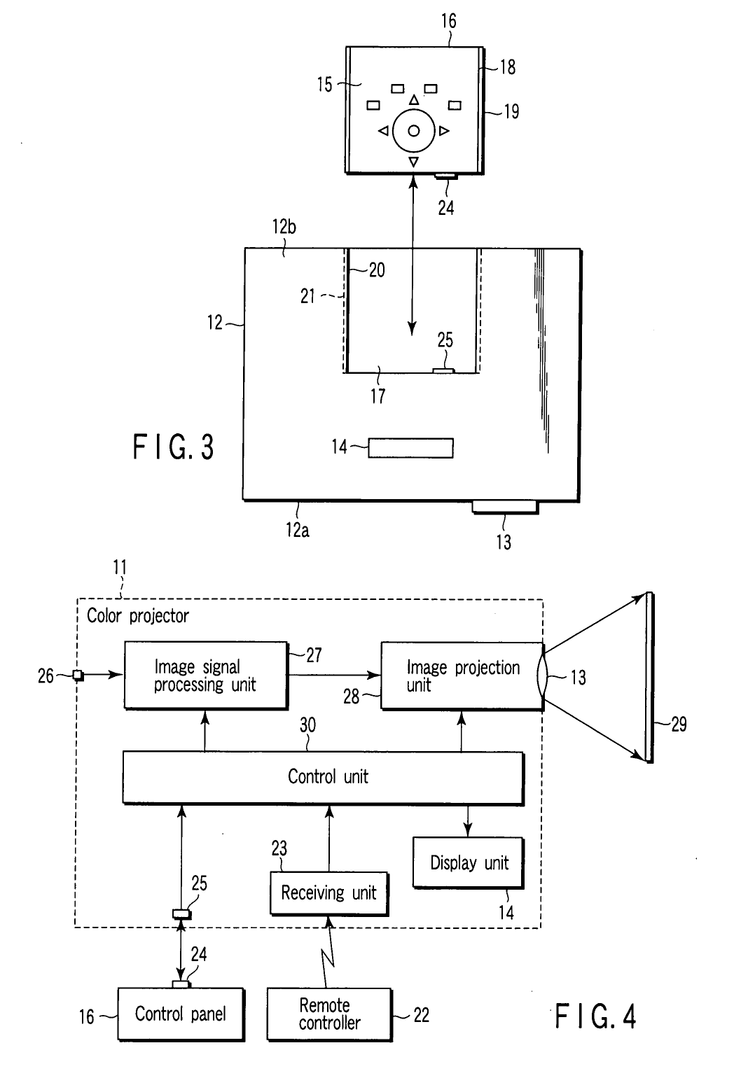

Here, in the surface at the tip of the control panel 16 in the direction of insertion into the attachment portion 17, a connector 24 is disposed for electrical connection to the signal processing system in the cabinet 12, as shown in FIG. 3.

On the other hand, in the attachment portion 17 of the cabinet 12, a connector 25 is disposed at a position which corresponds to the connector 24 when the control panel 16 is attached to the attachment portion 17. Thus, when the control panel 16 is attached to the attachment portion 17, the connectors 24 and 25 are connected to each other, thereby enabling electrical connection between the control panel 16 and the signal processing system in the cabinet 12.

FIG. 4 schematically shows the signal processing system of the color projector 11 described above. That is, an image signal supplied to an input terminal 26 is supplied to an image signal processing unit 27 where it is subjected to predetermined signal processing necessary for projection.

Subsequently, the image signal output from the image signal processing unit 27 is supplied to an image projection unit 28 and converted to an optical image, and then projected on a screen 29 via the projection lens 13 in a magnified manner, where the image is displayed.

A series of image projection operations of the color projector 11 described above is totally controlled by a control unit 30. This control unit 30 has, for example, a built-in central processing unit (CPU), and controls the various units on the basis of the operation information received from the control panel 16 via the connectors 24 and 25 or on the basis of the operation information received from the remote controller 22 via the receiving unit 23 so that the contents of the operation are reflected.

Furthermore, the control unit 30 controls the display unit 14 to display the current state of the color projector 11 and display the menu screen for setting the color projector 11 to various modes.

Here, the control unit 30 comprises a connection detection function for automatically detecting whether the control panel 16 is attached to the attachment portion 17, that is, whether the connector 24 of the control panel 16 is connected to the connector 25 of the attachment portion 17.

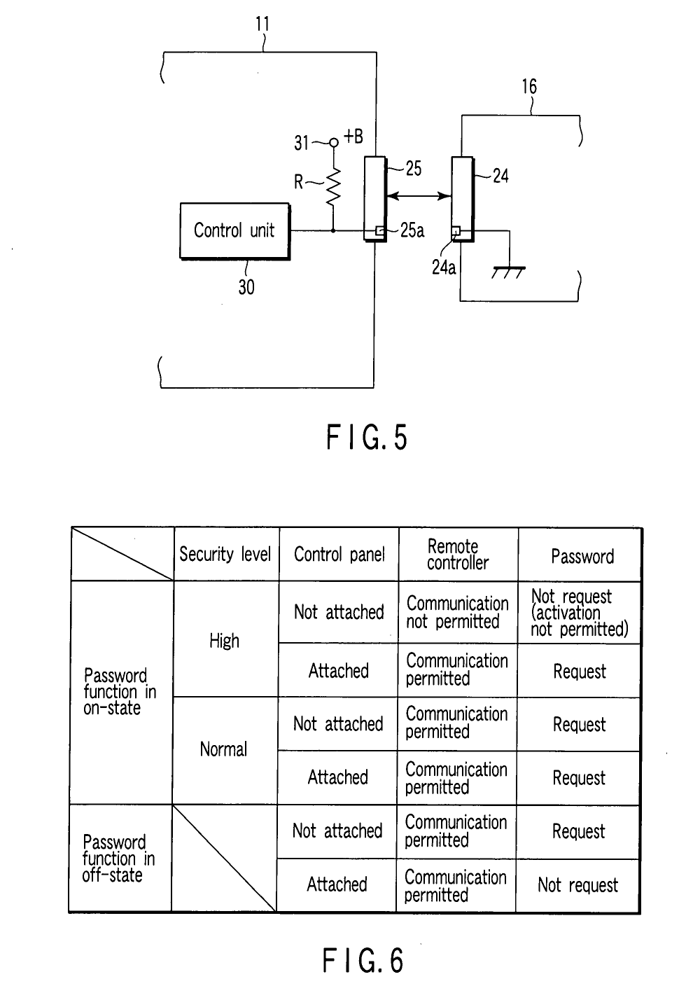

That is, as shown in FIG. 5, the connector 24 of the control panel 16 is provided with a dedicated detection terminal 24a for detecting whether this connector 24 is connected to the connector 25 of the attachment portion 17. The connector 25 of the attachment portion 17 is also provided with a dedicated detection terminal 25a for detecting whether the connector 24 of the control panel 16 is connected to this connector 25. These detection terminals 24a and 25a are provided so that they are connected to each other when the connectors 24 and 25 are connected to each other.

Then, the detection terminal 24a of the connector 24 is grounded in the control panel 16 such that its logical level is low (L). Moreover, the detection terminal 25a of the connector 25 is connected to the control unit 30 in the cabinet 12 and also connected to a power supply terminal 31 to which a reference potential +B is applied via a resistor R, so that the logical level of this detection terminal 25a is high (H).

Thus, if the connectors 24 and 25 are not connected to each other, the control unit 30 can judge that the control panel 16 is not attached to the attachment portion 17 because the logical level of this detection terminal 25a of the connector 25 is H. Moreover, if the connectors 24 and 25 are connected to each other, the control unit 30 can judge that the control panel 16 is attached to the attachment portion 17 because the logical level of the detection terminal 25a of the connector 25 is L.

Furthermore, the control unit 30 comprises a password function. This password function can be set to an on-state or off-state by the user. If the password function is set to the on-state, the control unit 30 requests the user to input a password when the power supply key 15a of the control panel 16 attached to the attachment portion 17 is turned on or when the power supply key 22a of the remote controller 22 is turned on.

The input of the password is achieved when the user operates the ten-key pad 22e of the remote controller 22 to input numbers of more than one digits (e.g., four digits). Then, the control unit 30 controls the color projector 11 so that the color projector 11 can be active only when the password input by the user matches with a preset password.

When the color projector 11 can be active, this means that the light projection from the projection lens 13 is enabled on the basis of an activation request, that is, the operation of turning on the power supply key 15a or 22a, and that the color projector 11 can be controlled to be brought into the various operation states and the stop state on the basis of the various kinds of operation information from the control panel 16 or the remote controller 22.

In addition, when the password input by the user does not match with the preset password, the control unit 30 does not accept the various kinds of operation information from the control panel 16 or the remote controller 22, and precludes the activation of the color projector 11. Moreover, when the password function is set to the off-state, the control unit 30 does not require the password and controls the color projector 11 so that the color projector 11 can be active.

Furthermore, the control unit 30 permits the user to selectively set a security level to “normal” or “high” higher than “normal”.

Then, when the power supply key 15a of the control panel 16 attached to the attachment portion 17 is turned on or when the power supply key 22a of the remote controller 22 is turned on, the control unit 30 limits the operation on the basis of the set on-state or off-state of the password function, the setting of the security level to “normal” or “high”, and the result of the detection by the connection detection function, as shown in FIG. 6.

That is, in the case where the password function is turned on, where the security level is “high”, and where the control panel 16 is not attached to the attachment portion 17, the control unit 30 precludes a communication with the remote controller 22, does not request the input of the password, and controls the color projector 11 so that the color projector 11 can not be active.

Furthermore, in the case where the password function is turned on, where the security level is “high”, and where the control panel 16 is attached to the attachment portion 17, the control unit 30 enables the communication with the remote controller 22, and controls to request the input of the password. Therefore, when a correct password is input, the color projector 11 can be active.

Still further, in the case where the password function is turned on, where the security level is “normal”, and where the control panel 16 is not attached to the attachment portion 17, the control unit 30 enables the communication with the remote controller 22, and controls to request the input of the password. Therefore, when a correct password is input, the color projector 11 can be active.

Still further, in the case where the password function is turned on, where the security level is “normal”, and where the control panel 16 is attached to the attachment portion 17, the control unit 30 enables the communication with the remote controller 22, and controls to request the input of the password. Therefore, when a correct password is input, the color projector 11 can be active.

Moreover, in the case where the password function is turned off and the control panel 16 is not attached to the attachment portion 17, the control unit 30 enables the communication with the remote controller 22, and controls to request the input of the password. That is, even if the password function is set to the off-state, that is, a state that does not require the input of the password, the control unit 30 automatically switches the password function to the on-state and controls to request the input of the password when the control panel 16 is not attached. Thus, the color projector 11 can be active only when a correct password is input.

Still further, in the case where the password function is turned off and the control panel 16 is attached to the attachment portion 17, the control unit 30 enables the communication with the remote controller 22, and controls so that the input of the password is not requested. That is, the color projector 11 can be active without inputting any password.

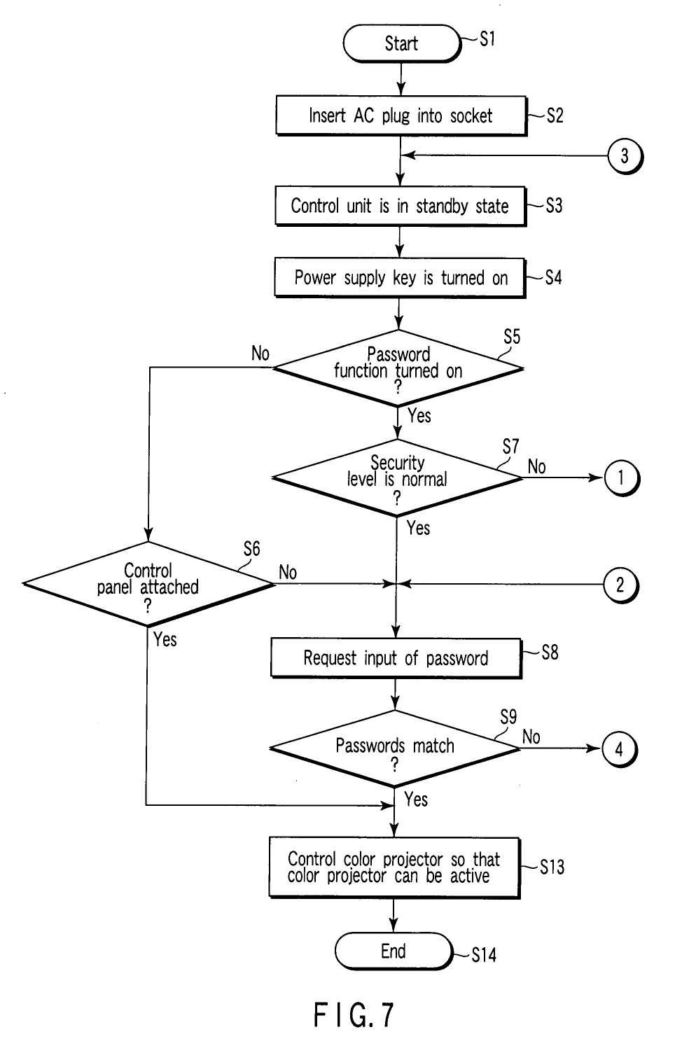

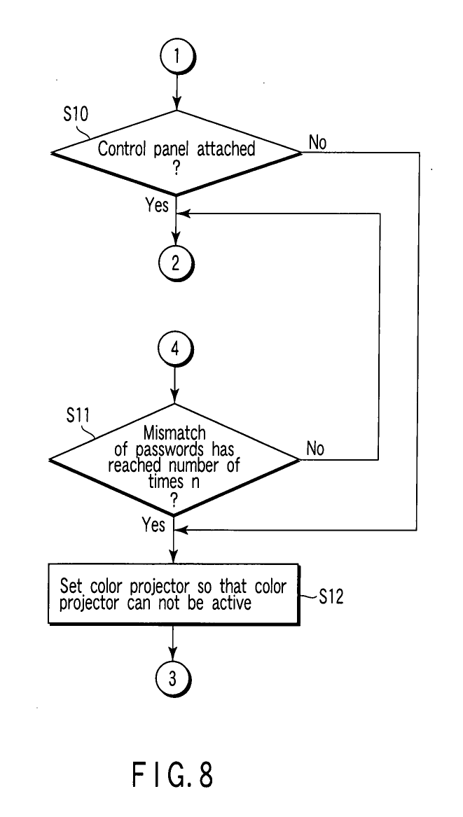

FIGS. 7 and 8 show flowcharts which sum up the operation of the control unit 30 shown in FIG. 6. That is, when processing is started (step S1) and an unshown alternating current (AC) commercial power supply plug of the color projector 11 is put into a socket in step S2, the control unit 30 is supplied with electric power and brought into a standby state in step S3.

In the standby state of the control unit 30, when the power supply key 15a of the control panel 16 attached to the attachment portion 17 or the power supply key 22a of the remote controller 22 is turned on in step S4, the control unit 30 judges in step S5 whether the password function is set to the on-state.

Then, when it is judged that the password function is not set to the on-state (NO), that is, when it is judged that the password function is set to the off-state, the control unit 30 judges in step S6 whether the control panel 16 is attached to the attachment portion 17. When it is judged that the control panel 16 is attached (YES), the control unit 30 controls the color projector 11 in step S13 so that the color projector 11 can be active, and terminates the processing (step S14).

Furthermore, when it is judged that in step S5 that the password function is set to the on-state (YES), the control unit 30 judges in step S7 whether the security level is set to “normal”.

Then, when it is judged that the security level is set to “normal” (YES) or when it is judged that in step S6 that the control panel 16 is not attached to the attachment portion 17 (NO), the control unit 30 displays in step S8 a message requesting the user to input the password on the display unit 14.

Subsequently, the control unit 30 judges in step S9 whether the password input by the user operating the ten-key pad 22e of the remote controller 22 matches with the preset password. When it is judged that they match with each other (YES), the control unit 30 controls the color projector 11 in step S13 so that the color projector 11 can be active, and then terminates the processing (step S14).

Furthermore, in step S7, when it is judged that the security level is not set to “normal”, that is, when it is judged that the security level is set to “high”, the control unit 30 judges in step S10 whether the control panel 16 is attached to the attachment portion 17.

Then, when it is judged that the control panel 16 is attached to the attachment portion 17 (YES), the control unit 30 is shifted to the processing in step S8. Moreover, when it is judged in step S10 that the control panel 16 is not attached to the attachment portion 17 (NO), the control unit 30 sets the color projector 11 in step S12 so that the color projector 11 can not be active, and the control unit 30 turns off the power supply key 15a or 22a that is turned on, such that the control unit 30 is returned to the processing in step S3.

Furthermore, when it is judged in step S9 that the password input by the user does not match with the preset password (NO), the control unit 30 judges in step S11 whether the mismatch of the passwords has reached a preset number of times n (e.g., five times). When it is judged that this number of times has not been reached (NO), the control unit 30 is shifted to the processing in step S8.

Furthermore, when it is judged that in step S11 that the mismatch of the passwords has reached the preset number of times n (YES), the control unit 30 sets the color projector 11 in step S12 so that the color projector 11 can not be active, and the control unit 30 turns off the power supply key 15a or 22a that is turned on, such that the control unit 30 is returned to the processing in step S3.

According to the embodiment described above, when the power supply key 15a of the control panel 16 attached to the attachment portion 17 or the power supply key 22a of the remote controller 22 is turned on, the color projector 11 is controlled so that the color projector 11 can be active or can not be active on the basis of a combination of the set state of the password function, the set state of the security level and the result of the detection by the connection detection function. This enables the color projector 11 to be sufficiently protected against theft, unauthorized use, etc. with a simple configuration, and increases the degree of freedom of handling for an owner to be suitable for practical use.

Especially, the security level can be selectively set to two levels; “high” and “normal”. When the security level is “high”, the communication with the remote controller 22 is precluded and the color projector 11 can not be active unless the control panel 16 is attached even if the password function is in the on-state. On the contrary, when the security level is “normal”, the communication with the remote controller 22 is enabled and a password is requested as long as the password function is in the on-state even if the control panel 16 is not attached.

That is, the color projector 11 can be selectively controlled so that the color projector 11 can be active or can not be active in accordance with the security level set by the user even if the control panel 16 is not attached. This makes it possible to increase the degree of freedom of handling for the owner and thus enhance practicability.

Furthermore, even if the password function is set to the off-state, that is, a state that does not require the input of the password, the password function is switched to the on-state and the input of the password is requested when the control panel 16 is not attached. This also enables the color projector 11 to be sufficiently protected against theft, unauthorized use, etc.

Next, there will be described the above-mentioned setting of the password function to the on-state or the off-state, the setting of the security level and the change of the password. That is, when the color projector 11 is controlled in step S13 so that the color projector 11 can be active, the menu key 15b of the control panel 16 attached to the attachment portion 17 or the menu key 22b of the remote controller 22 is operated.

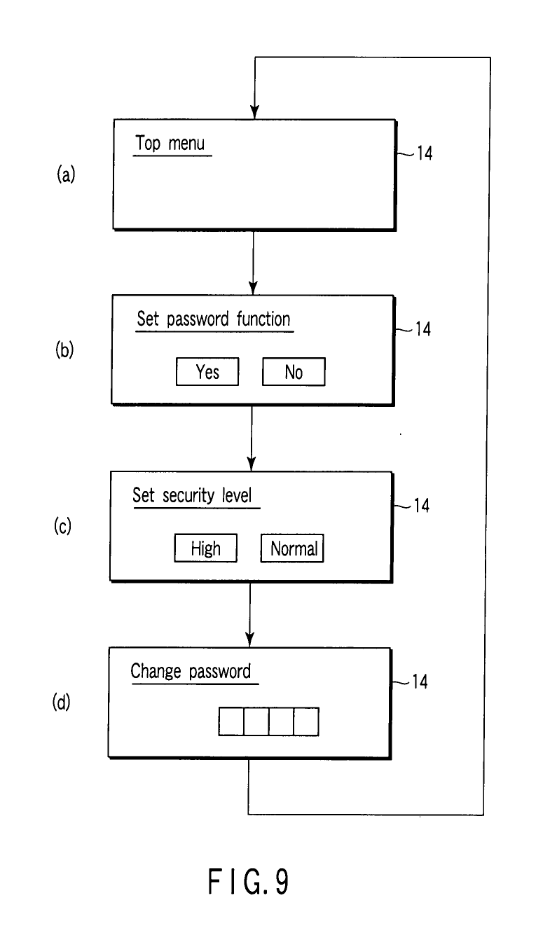

Then, the control unit 30 displays a top menu screen as shown in (a) of FIG. 9 on the display unit 14. While this top menu screen is being displayed, the display unit 14 is sequentially switched to a password function setting screen as shown in (b) of FIG. 9, a security level setting screen as shown in (c) of FIG. 9 and a password change screen as shown in (d) of FIG. 9 each time the predetermined (e.g., downward) direction key 15c of the control panel 16 attached to the attachment portion 17 or the predetermined (e.g., downward) direction key 22c of the remote controller 22 is operated, and the display unit 14 again returns to the top menu screen shown in (a) of FIG. 9.

Thus, the user causes the display unit 14 to display a screen corresponding to the function that this user desires to set, and then operates the decision key 15d of the control panel 16 attached to the attachment portion 17 or the decision key 22d of the remote controller 22.

For example, assume that the password function setting screen shown in (b) of FIG. 9 has been selected and decided. In this password function setting screen, two kinds of items are displayed: an item “yes” for setting the password function into the on-state, and an item “no” for setting the password function into the off-state.

Thus, the user operates the predetermined (e.g., horizontal) direction key 15c of the control panel 16 attached to the attachment portion 17 or the predetermined (e.g., horizontal) direction key 22c of the remote controller 22 to select a desired item, and operates the decision key 15d or 22d, such that the password function can be set to the on-state or off-state.

Furthermore, for example, assume that the security level setting screen shown in (c) of FIG. 9 has been selected and decided. In this security level setting screen, two kinds of items are displayed: an item “high” for setting the security level to “high”, and an item “normal” for setting the security level to “normal”.

Thus, the user operates the predetermined (e.g., horizontal) direction key 15c of the control panel 16 attached to the attachment portion 17 or the predetermined (e.g., horizontal) direction key 22c of the remote controller 22 to select a desired item, and operates the decision key 15d or 22d, such that the security level can be set to “high” or “normal”.

Furthermore, for example, assume that the password change screen shown in (d) of FIG. 9 has been selected and decided. In this password change screen, an item is displayed to set a four-digit numerical password. In this case, the user operates the ten-key pad 22e of the remote controller 22 to input four numbers, and operates the decision key 22d, such that the password can be changed.

In addition, in the embodiment described above, the display unit 14 is disposed in the cabinet 12 of the color projector 11, and this display unit 14 displays the current state of the color projector 11 and the menu screen for setting the color projector 11 to various modes.

It should however be understood that the invention is not limited to this, and, for example, the image projection function of the color projector 11 may be used to display the current state in an actual projected image by on screen display (OSD) or display the menu screen to set the various modes.

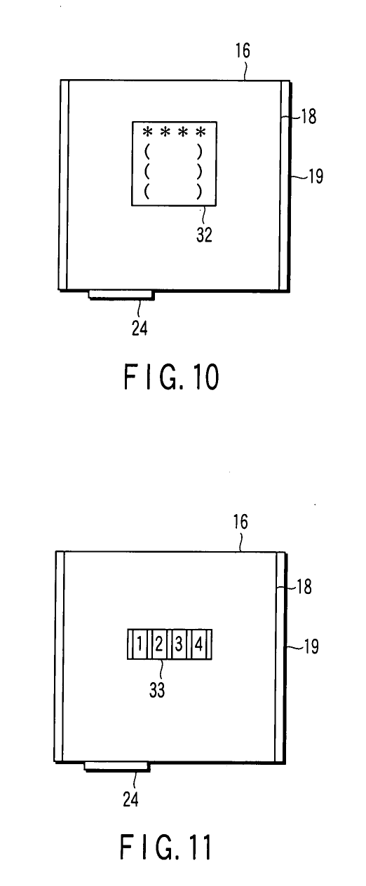

Here, as shown in FIG. 10, it would be convenient if a label 32 is affixed to a surface of the control panel 16 opposite to the surface in which the operation unit 15 is formed, and a password is written on this label 32 and indicated. In this case, in the label 32, a predetermined password (indicated by * in the drawing) input at the time of shipment on the side of the manufacturer of the color projector 11 has already been written, and a plurality of sections (indicated by parentheses in the drawing) are provided where the changed password is written in case the user has changed the password.

Furthermore, as shown in FIG. 11, in the surface of the control panel 16 opposite to the surface in which the operation unit 15 is formed, a number memory unit 33 can be disposed to enable the four-digit number to be changed on a dial, and the currently set password can be stored and displayed in this number memory unit 33.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projection type display device comprising:
a main unit configured to be equipped with a projection lens;
a password unit configured to request the input of a password in response to an operation of requesting the activation of the main unit and to control the main unit so that the main unit is active when the input password matches with a preset password;
a password function setting unit configured to selectively set the password unit to an on-state to request the input of the password in response to the operation of requesting the activation of the main unit or to an off-state to control the main unit so that the main unit is active without requesting the input of the password;
a control panel configured detachably from the main unit and configured to have an operation unit which controls the main unit so that the main unit is in a predetermined operation state or a stop state when the control panel is attached to the main unit and when the main unit is controlled so that the main unit is active; and
a control unit configured to request the input of the password in response to the operation of requesting the activation of the main unit unless the control panel is attached to the main unit even when the password unit is set to the off-state by the password function setting unit.

2. A projection type display device according to claim 1, wherein
the control unit is configured to bring the main unit into an active state without requesting the input of the password in response to the operation of requesting the activation of the main unit when the control panel is attached to the main unit in the case where the password unit is set to the off-state by the password function setting unit.

3. A projection type display device according to claim 1, wherein
the control unit is configured to request the input of the password in response to the operation of requesting the activation of the main unit regardless of whether the control panel is attached to the main unit in the case where the password unit is set to the on-state by the password function setting unit.

4. A projection type display device according to claim 1, further comprising:
a detection unit configured to detect whether or not the control panel is attached to the main unit,
wherein the control unit is configured to request the input of the password in response to the operation of requesting the activation of the main unit in the case where the detection unit detects that the control panel is not attached to the main unit even when the password unit is set to the off-state by the password function setting unit.

5. A projection type display device according to claim 1, wherein
the operation unit of the control panel is configured to include a key to perform the operation of requesting the activation of the main unit.

6. A projection type display device according to claim 1, wherein
the key to perform the operation of requesting the activation of the main unit is configured to be provided in a remote controller, the remote controller remotely operating the main unit which has been controlled and brought into the active state to bring the main unit into a predetermined operation state and a stop state.

7. A projection type display device according to claim 6, wherein
the password is configured to be input by the remote controller.

8. A projection type display device according to claim 1, wherein
the control panel is provided with a display unit configured to display the password.

9. A projection type display device according to claim 1, further comprising:
a security level setting unit configured to selectively set a security level to a first level or to a second level higher than the first level,
wherein the control unit is configured to bring the main unit into an inactive state when the control panel is not attached to the main unit in the case where the password unit is set to the on-state by the password function setting unit and in the case where the security level is set to the second level by the security level setting unit.

10. A projection type display device according to claim 9, wherein
the control unit is configured to request the input of the password in response to the operation of requesting the activation of the main unit when the control panel is attached to the main unit in the case where the password unit is set to the on-state by the password function setting unit and in the case where the security level is set to the second level by the security level setting unit.

11. A projection type display device according to claim 9, wherein
the control unit is configured to request the input of the password in response to the operation of requesting the activation of the main unit regardless of whether the control panel is attached to the main unit in the case where the password unit is set to the on-state by the password function setting unit and in the case where the security level is set to the first level by the security level setting unit.

12. A method of controlling a projection type display device which includes:
a main unit configured to be equipped with a projection lens;
a password unit configured to request the input of a password in response to an operation of requesting the activation of the main unit and to control the main unit so that the main unit is active when the input password matches with a preset password;
a password function setting unit configured to selectively set the password unit to an on-state to request the input of the password in response to the operation of requesting the activation of the main unit or to an off-state to control the main unit so that the main unit is active without requesting the input of the password; and
a control panel configured detachably from the main unit and configured to have an operation unit which controls the main unit so that the main unit is in a predetermined operation state or a stop state when the control panel is attached to the main unit and when the main unit is controlled so that the main unit is active, the method comprising:
judging whether the password unit is set to the off-state by the password function setting unit in response to the operation of requesting the activation of the main unit;
judging whether the control panel is attached to the main unit when the password unit is judged to be set to the off-state; and
requesting the input of the password when the control panel is judged not to be attached to the main unit.

13. A method according to claim 12, wherein
the projection type display device further comprises a security level setting unit which selectively sets a security level to a first level or to a second level higher than the first level,
wherein requesting the input of the password includes controlling the main unit so that the main unit is brought to an inactive state when the control panel is not attached to the main unit in the case where the password unit is set to the on-state and in the case where the security level is set to the second level.
